(19) United States
(12) Patent Application Publication
(10) Pub. No.: US 2024/0120821 A1
(43) Pub. Date: Apr. 11, 2024

(54) POWER CONVERSION DEVICE AND CONTROL METHOD FOR POWER CONVERSION DEVICE

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventors: Tsunehito FUJITA, Koganei Tokyo (JP); Toshiyuki BABA, Kawaguchi Saitama (JP); Yuichiro NOZAKI, Mitaka Tokyo (JP); Hiroomi SUZUKI, Koshigaya Saitama (JP)

(21) Appl. No.: 18/032,777

(22) PCT Filed: Oct. 20, 2021
(86) PCT No.: PCT/JP2021/038799

§ 371 Date: Nov. 22, 2023

(30) Foreign Application Priority Data
Oct. 22, 2020 (JP) 2020-177592

(51) Int. Cl. H02M 1/00; H02M 1/32; H02M 1/36; H02M 3/335; H02M 7/48

(52) U.S. Cl. CPC H02M 1/0006; H02M 1/327; H02M 1/36; H02M 3/33569; H02M 7/4815; H02M 1/0009; H02M 1/0058

(57) ABSTRACT

A power conversion device according to an embodiment includes: a voltage regulator circuit configured to regulate power from a power source to a desired voltage; an inverter configured to convert the power output from the voltage regulator circuit into an alternate current power; a resonant circuit having inductance and capacitance; a high frequency transformer configured to convert the alternate current power of the inverter; a rectifier configured to convert the alternate current power output from the high frequency transformer into a direct current power; a temperature detector configured to detect a temperature of the resonant circuit; and a controller configured to detect an anomalous resonant frequency when the temperature is equal to or higher than a predetermined temperature threshold to control an anomalous state.

### FIELD

Embodiments of the present invention relate to a power conversion device and a control method for the power conversion device.

### BACKGROUND

In the related art, power conversion devices have become smaller and lighter, but there is demand for further reductions in size and weight.

To achieve a smaller and lighter power conversion device, there is proposed a circuit system obtained by employing a DC/DC converter circuit having a soft switching function in which a resonant circuit is used in a part of the circuit and making this circuit to behave at high frequencies, thereby reducing the outer size and mass of a reactor and a transformer within the device.

Such a circuit system typically employs soft switching technology using a resonant circuit (that is, a switching element is turned on or off when a current is forcibly reduced), so that it is possible to reduce losses in the switching element despite high-frequency switching.

However, in a case where this circuit system is employed, when a resonant frequency of the resonant circuit decreases for some reason, the switching element is turned off while a current is applied to the switching element (that is, hard switching is performed), which may increase the losses. Furthermore, an increase in resonant frequency may increase the current amplitude and thus increase resistance losses in each component.

In addition, high-frequency switching causes a rapid temperature rise. For this reason, even when a device includes a thermistor on a cooler to detect an overtemperature, a semiconductor element may be damaged before the overtemperature detection.

In order to solve these problems, the following method has been proposed. That is, a current detector is disposed in a resonant circuit to detect a resonant current and monitor a resonant frequency, and when the resonant frequency deviates from a predetermined range, an anomaly is detected and a device is stopped.

### CITATION LIST

### Patent Literature

Patent Literature 1: JP 6067136 B1
Patent Literature 2: U.S. Pat. No. 8,614,901

### SUMMARY OF THE INVENTION

### Problem to be Solved by the Invention

The aforementioned method in the related art requires installation of a current detector.

However, a current detector generates a large amount of heat at high frequencies, which causes difficulty in applying the current detector to a device used with strict temperature environment.

In addition, the outer size of a high-frequency current detector is large, which raises other problems of mismatching with the inner space of a device and of cost increase.

Furthermore, even when these problems are solved, a high-speed microcomputer or FPGA is required as a detection circuit, and the increase in costs is a problem that remains to be solved.

The present invention has been made in light of the problems, and an object of the invention is to provide a high-frequency insulated power conversion device and a control method for the power conversion device, capable of detecting an anomalous resonant frequency with ease and at low cost.

### Means for Solving Problem

A power conversion device according to an embodiment includes: a voltage regulator circuit configured to regulate power from a power source to a desired voltage; an inverter configured to convert the power output from the voltage regulator circuit into an alternate current power; a resonant circuit having inductance and capacitance; a high frequency transformer configured to convert the alternate current power of the inverter; a rectifier configured to convert the alternate current power output from the high frequency transformer into a direct current power; a temperature detector configured to detect a temperature of the resonant circuit; and a controller configured to detect an anomalous resonant frequency when the temperature is equal to or higher than a predetermined temperature threshold to control an anomalous state.

### BRIEF DESCRIPTION OF DRAWINGS

FIG. 1 is a schematic view for describing a configuration of a power conversion device according to a first embodiment.

FIG. 2 is a view for describing the relation between gate voltages of switching elements and currents of the members at a normal resonant frequency.

FIG. 3 is a view for describing the relation between gate voltages of the switching elements and currents of the members at an anomalous resonant frequency.

FIG. 4 is a flowchart of first processing for detecting an anomalous resonant frequency.

FIG. 5 is a flowchart of second processing for detecting an anomalous resonant frequency.

FIG. 6 is a flowchart of third processing for detecting an anomalous resonant frequency.

FIG. 7 is a schematic view for describing a configuration of a power conversion device according to a second embodiment.

FIG. 8 is a schematic view for describing a configuration of a power conversion device according to a third embodiment.

FIG. 9 is a schematic view for describing a configuration of a power conversion device according to a fourth embodiment.

FIG. 10 is a schematic view for describing a configuration of a power conversion device according to a fifth embodiment.

### DETAILED DESCRIPTION

Hereinafter, embodiments will be described with reference to the drawings.

### [1] FIRST EMBODIMENT

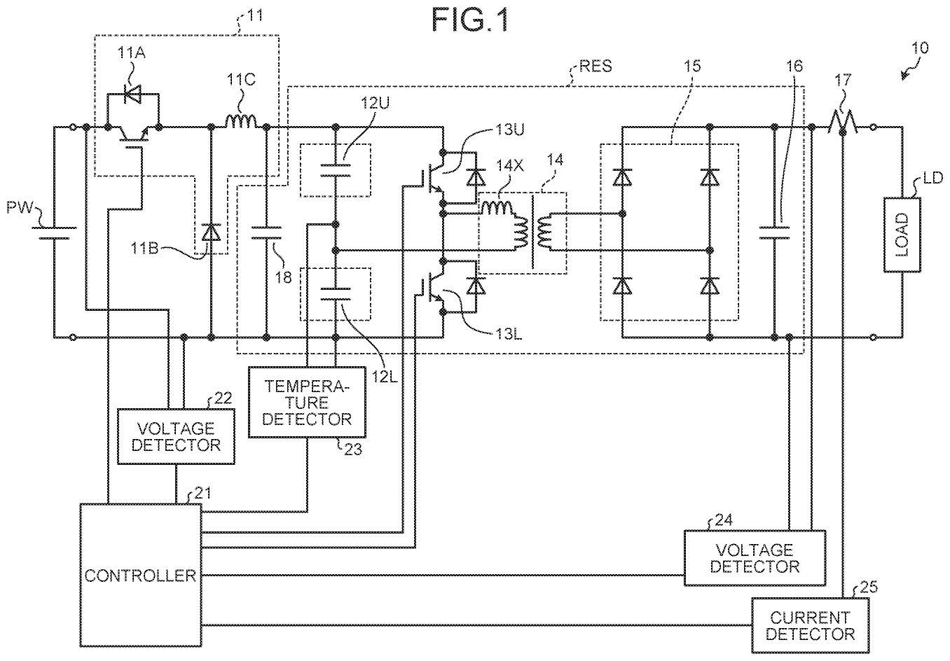

FIG. 1 is a schematic view for describing a configuration of a power conversion device according to a first embodiment.

The power conversion device includes a power source PW, a voltage regulator circuit 11, resonant capacitors 12U and 12L included in a resonant inverter as a resonant single-phase half-bridge inverter, a switching element 13U, a switching element 13L, a high frequency transformer 14, a diode rectifier 15, a filter capacitor 16, a current detector 17, a filter capacitor 18, a controller 21, a voltage detector 22 for detecting an input voltage of the voltage regulator circuit 11, a temperature detector 23 for detecting a temperature representing the temperatures of the resonant capacitor 12U and the resonant capacitor 12L, a voltage detector 24 for detecting an output voltage of the power conversion device, and a current detector 25 for detecting an output current of the power conversion device based on an output single from the current detector 17.

In the configuration, the resonant capacitors 12U and 12L, the switching element 13U, the switching element 13L, the high frequency transformer 14, the diode rectifier 15, the filter capacitor 16, and the filter capacitor 18 are included in a resonant circuit RES.

In the example illustrated in FIG. 1, the voltage regulator circuit 11 is illustrated as a step-down chopper circuit including a switching element 11A, a diode 11B, and a coil 11C. However, note that the voltage regulator circuit 11 may employ any circuit such as a step-up/step-down chopper circuit, a step-up chopper circuit, and a converter as long as the circuit performs the voltage regulation to obtain a desired voltage.

Furthermore, the high frequency transformer 14 includes a leakage inductance component 14X.

The controller 21 is connected to the voltage detector 22, the temperature detector 23, the voltage detector 24, and the current detector 25. While causing the voltage detector 24 and the current detector 25 to detect output, the controller 21 controls a gate of the switching element 11A based on predetermined control characteristics.

In FIG. 1, the switching element 11A, the switching element 13U, and the switching element 13L are illustrated as IGBTs but are not limited thereto. For example, those elements may be SiC-MOSFETs, power transistors, or GTO thyristors.

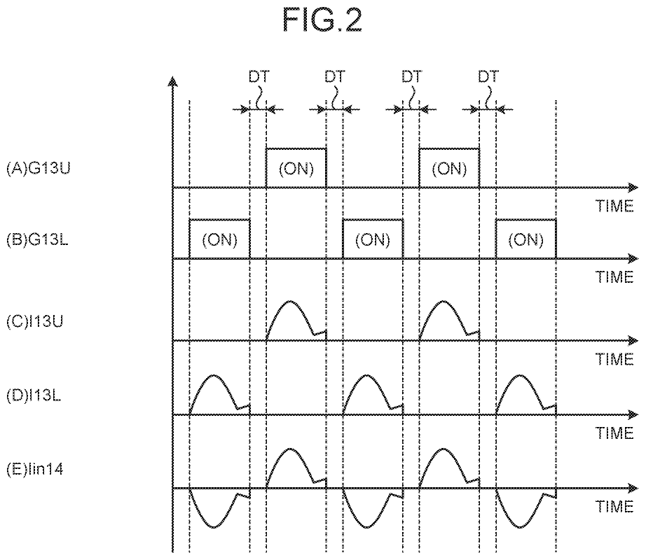

FIG. 2 is a view for describing the relation between gate voltages of switching elements and currents of the members at a normal resonant frequency.

As illustrated in FIGS. 2(A) and 2(B), a gate voltage G13U of the switching element 13U and a gate voltage G13L of the switching element 13L are switched exclusively between “H” level (ON) and “L” level (OFF) with a predetermined dead time DT involved.

When the switching element 13U is in the on state, a current 113U flows through the switching element 13U as illustrated in FIG. 2(C). Similarly, when the switching element 13L is in the on state, a current 113L flows through the switching element 13L as illustrated in FIG. 2(D).

Accordingly, a current Iin14 flows through the primary side of the high frequency transformer 14 as illustrated in FIG. 2(E).

In the normal state, the controller 21 controls the switching elements 13U and 13L in a set switching cycle.

The resonant circuit RES is formed by the total of inductance of a wire in a conductor including a closed circuit of the switching elements 13U and 13L, the high frequency transformer 14, the diode rectifier 15, and the filter capacitors 16 and 18 and the leakage inductance 14X of the high frequency transformer 14 and by the resonant capacitors 12U and 12L, and power is supplied to a load.

Accordingly, a switching frequency and a resonant frequency achieve soft switching (turn off with a small current).

In other words, as illustrated in FIG. 2, in the first half of the switching cycle, a flow of the current I13U is large in the first half of the period when the gate voltage G13U of the switching element 13U is at “H” level, and the flow of the current I13U is small during the dead time DT set for switching the switching elements 13U and 13L, thereby enabling soft switching.

Furthermore, in the second half of the switching cycle, a flow of the current I13L is large in the first half of the period when the gate voltage G13L of the switching element 13L is at “H” level, and the flow of the current I13L is small during the dead time DT set for switching the switching elements 13U and 13L, thereby enabling soft switching.

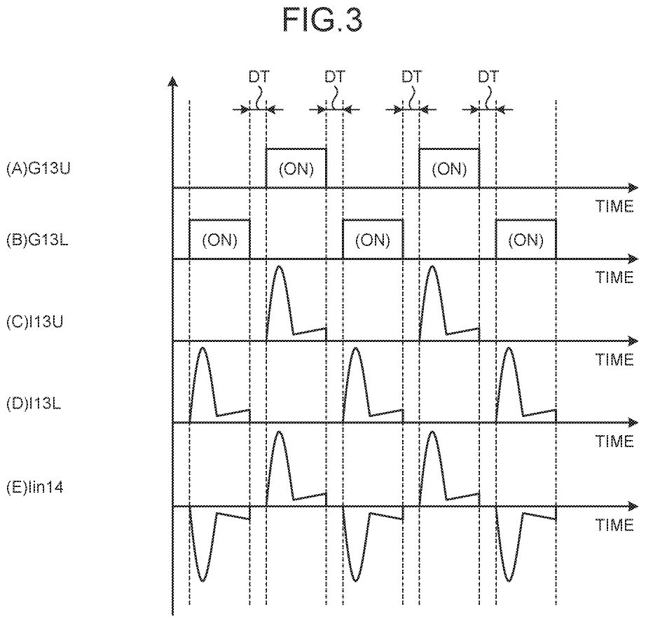

FIG. 3 is a view for describing the relation between gate voltages of the switching elements and currents of the members at an anomalous resonant frequency due to a decrease in capacitance of the resonant capacitors.

At an anomalous resonant frequency, in the first half of the switching cycle T, a flow of the current I13U is large in the first half of the period when the gate voltage G13U of the switching element 13U is at “H” level, and the flow of the current I13U is small during the dead time DT set for switching the switching elements 13U and 13L.

However, a value of the current flowing in the first half of the period when the gate voltage G13U of the switching element 13U is at “H” level is larger than the value in the normal state, which increases an amount of heat generation of the entire circuit.

Similarly, in the second half of the switching cycle, a flow of the current I13L is large in the first half of the period when the gate voltage G13L of the switching element 13L is at “H” level, and the flow of the current I13L is small during the dead time DT set for switching the switching elements 13U and 13L.

However, a value of the current flowing in the first half of the period when the gate voltage G13L of the switching element 13L is at “H” level is larger than the value in the normal state, which increases power consumption and also increases an amount of heat generation of the entire circuit.

More specifically, the resonant frequency f is represented by Formula (1) where L is the inductance of the entire resonant circuit and C is the capacitance of the entire resonant circuit.

f=½π·√(L·C) (1)

The smaller the capacitance C, the higher the resonant frequency. Therefore, the entire circuit cannot perform a desired operation.

In this embodiment, a change in resonant frequency is detected by detecting a temperature change, thereby performing control.

In other words, the temperature detector 23 is used to monitor the temperature of the resonant capacitors 12U and 12L or the temperature of a conductor connected to the resonant capacitors 12U and 12L.

When the temperature detector 23 determines that the temperature deviates from a temperature range in the normal state, the controller 21 detects an anomalous resonant frequency based on output of the temperature detector 23 and changes the mode of the power conversion device 10 to stop mode.

Hereinafter, an operation of the controller 21 will be described in more detail.

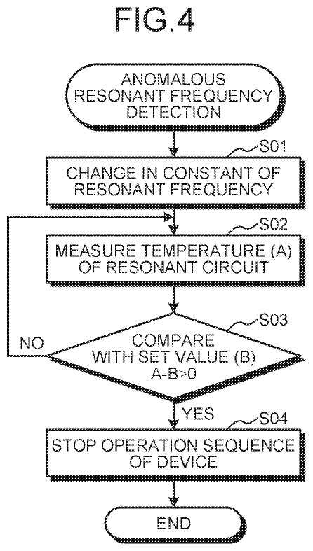

FIG. 4 is a flowchart of first processing for detecting an anomalous resonant frequency.

In an anomalous state of the resonant frequency in which the constant of the resonant frequency is changed (Step S01), the controller 21 measures the temperature of the resonant circuit, that is, the resonant capacitors 12U and 12L or the conductor connected to the resonant capacitors 12U and 12L, through the temperature detector 23, thereby obtaining a temperature measured value A (Step S02).

Next, the controller 21 compares the temperature measured value A with a temperature set value B corresponding to a preset temperature threshold and determines whether the temperature measured value A is equal to or higher than the temperature set value B (A−B≥0) (Step S03).

When the temperature measured value A is determined to be equal to or higher than the temperature set value B (A−B≥0) in Step S03 (Step S03; Yes), the controller 21 stops the operation sequence of the power conversion device 10 (Step S04) to protect the power conversion device 10.

When the temperature measured value A is determined to be lower than the temperature set value B (A-B≤0) in Step S03 (Step S03; No), the controller 21 moves back to Step S02 and repeats similar processing.

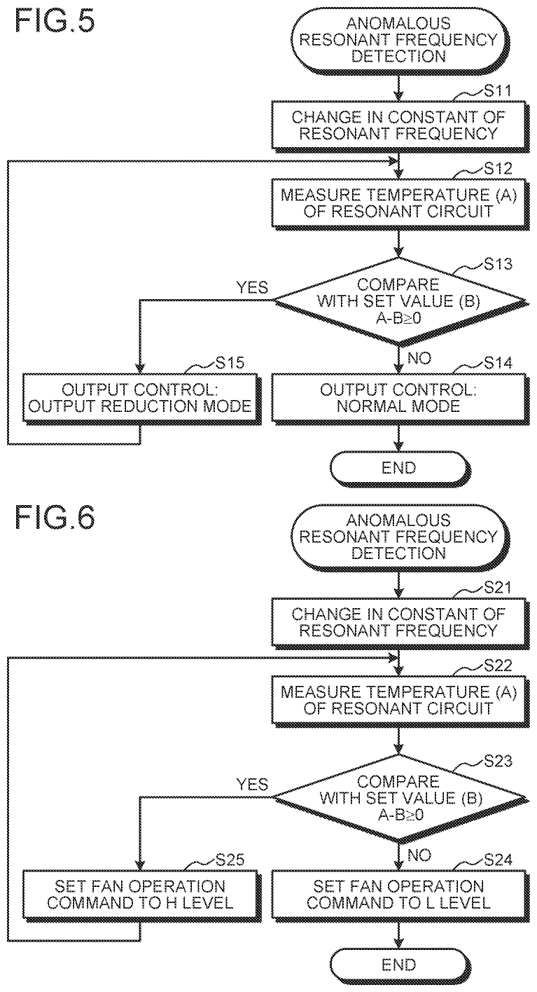

FIG. 5 is a flowchart of second processing for detecting an anomalous resonant frequency.

At an anomalous resonant frequency, the operation sequence of the power conversion device 10 is stopped in the processing illustrated in FIG. 4, but in the processing illustrated in FIG. 5, output is reduced to protect the power conversion device 10.

In an anomalous state of the resonant frequency in which the constant of the resonant frequency is changed (Step S11), the controller 21 measures the temperature of the resonant circuit, that is, the resonant capacitors 12U and 12L or the conductor connected to the resonant capacitors 12U and 12L, through the temperature detector 23, thereby obtaining a temperature measured value A (Step S12).

Next, the controller 21 compares the temperature measured value A with a temperature set value B corresponding to a preset temperature threshold and determines whether the temperature measured value A is equal to or higher than the temperature set value B (A-B 0) (Step S13).

When the temperature measured value A is determined to be equal to or higher than the temperature set value B (A-B 0) in Step S13 (Step S13; Yes), the controller 21 controls output of the power conversion device 10 and changes the mode of the power conversion device 10 to output reduction mode which reduces output (Step S15) to protect the power conversion device 10. To determine whether a further reduction in output is required, the controller 21 moves back to Step S12 and repeats similar processing.

When the temperature measured value A is determined to be lower than the temperature set value B (A−B<0) in Step S13 (Step S13; No), the controller 21 ends the processing while maintaining the output control in normal mode (Step S14).

FIG. 6 is a flowchart of third processing for detecting an anomalous resonant frequency.

In this example, described is a case where the power conversion device is provided with a cooling fan as a cooler for cooling the resonant capacitors 12U and 12L included in the resonant circuit.

At an anomalous resonant frequency, the operation sequence of the power conversion device 10 is stopped in the processing illustrated in FIG. 4, but in the processing illustrated in FIG. 6, the resonant capacitors 12U and 12L and peripheral circuits are cooled to protect the power conversion device 10.

In an anomalous state of the resonant frequency in which the constant of the resonant frequency is changed (Step S21), the controller 21 measures the temperature of the resonant circuit, that is, the resonant capacitors 12U and 12L or the conductor connected to the resonant capacitors 12U and 12L, through the temperature detector 23, thereby obtaining a temperature measured value A (Step S22).

Next, the controller 21 compares the temperature measured value A with a temperature set value B corresponding to a preset temperature threshold and determines whether the temperature measured value A is equal to or higher than the temperature set value B (A−B≥0) (Step S23).

When the temperature measured value A is determined to be equal to or higher than the temperature set value B (A−B≥0) in Step S23 (Step S23; Yes), the controller 21 sets a fan operation command for controlling the operation of the cooling fan at “H” level and activates the cooling fan (Step S25), thereby cooling the resonant capacitors 12U and 12L and the peripheral circuits to protect the power conversion device 10.

When the temperature measured value A is determined to be lower than the temperature set value B (A−B<0) in Step S23 (Step S23; No), the controller 21 sets the fan operation command for controlling the operation of the cooling fan at “L” level to stop the cooling fan or to end the processing while maintaining the cooling fan in the stop state (Step S24).

In this manner, according to the first embodiment, it is possible to detect an anomalous resonant frequency with ease and at low cost, and it is possible to protect the power conversion device 10.

### [2] SECOND EMBODIMENT

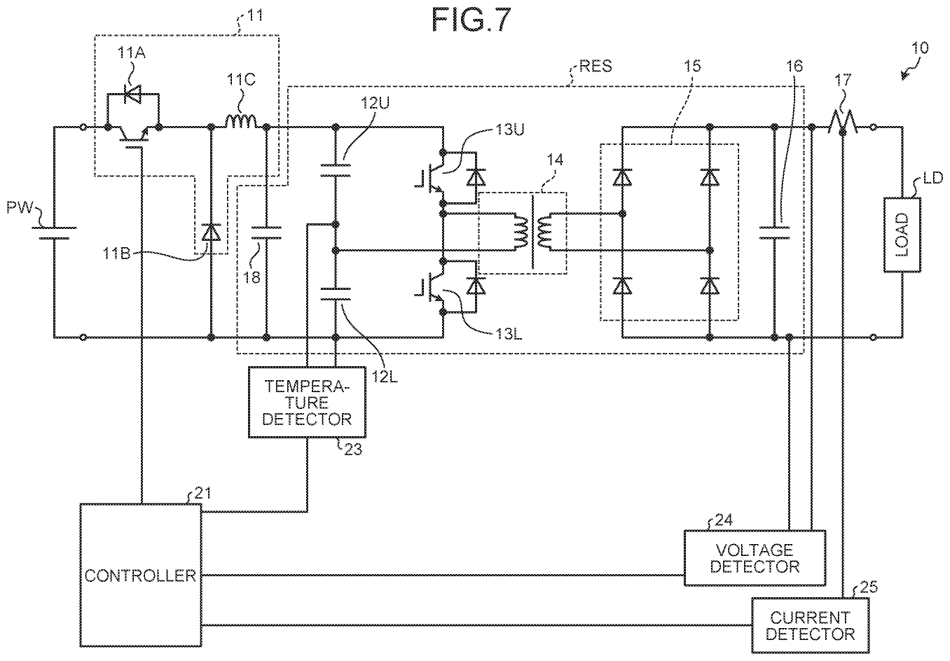

FIG. 7 is a schematic view for describing a configuration of a power conversion device according to a second embodiment.

In FIG. 7, parts similar to those of the first embodiment illustrated in FIG. 1 are denoted by the same reference numerals.

The second embodiment is different from the first embodiment in that the power conversion device 10 is not provided with the voltage detector 22 for detecting an input voltage of a voltage regulator circuit 11.

With this configuration, instead of the voltage regulator circuit 11, an output voltage to a load LD which is to be regulated ultimately is detected and controlled as in the first embodiment, so that the configuration of the circuit is simplified.

With the configuration simpler than the first embodiment, the second embodiment enables the detection of an anomalous resonant frequency with ease and at low cost and enables the protection of the power conversion device 10.

### [3] THIRD EMBODIMENT

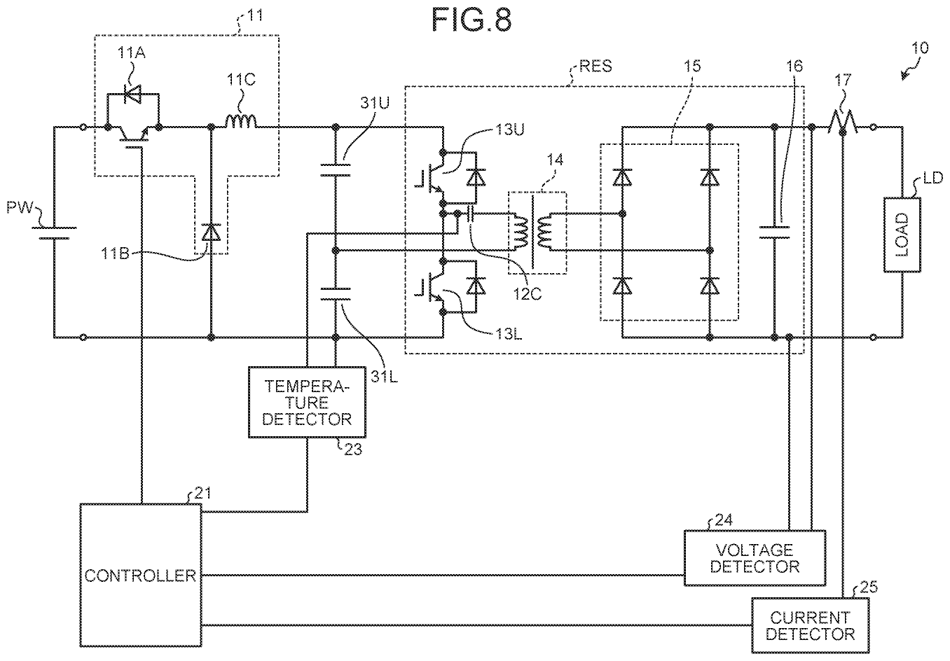

FIG. 8 is a schematic view for describing a configuration of a power conversion device according to a third embodiment.

The third embodiment illustrated in FIG. 8 is different from the first embodiment illustrated in FIG. 1 in that the power conversion device 10 is provided with a resonant capacitor 12C between a connection point of switching elements 13U and 13L and a primary winding of a high frequency transformer 14, that the power conversion device 10 is provided with a voltage-dividing capacitor 31U and a voltage-dividing capacitor 31L, instead of a resonant capacitor 12U and a resonant capacitor 12L, which are larger in capacitance than the resonant capacitor 12U and the resonant capacitor 12L, and that the temperature detector 23 is used to measure the temperature around the resonant capacitor 12C.

Similarly to the first embodiment, the third embodiment enables the detection of an anomalous resonant frequency with ease and at low cost and enables the protection of the power conversion device 10.

### [4] FOURTH EMBODIMENT

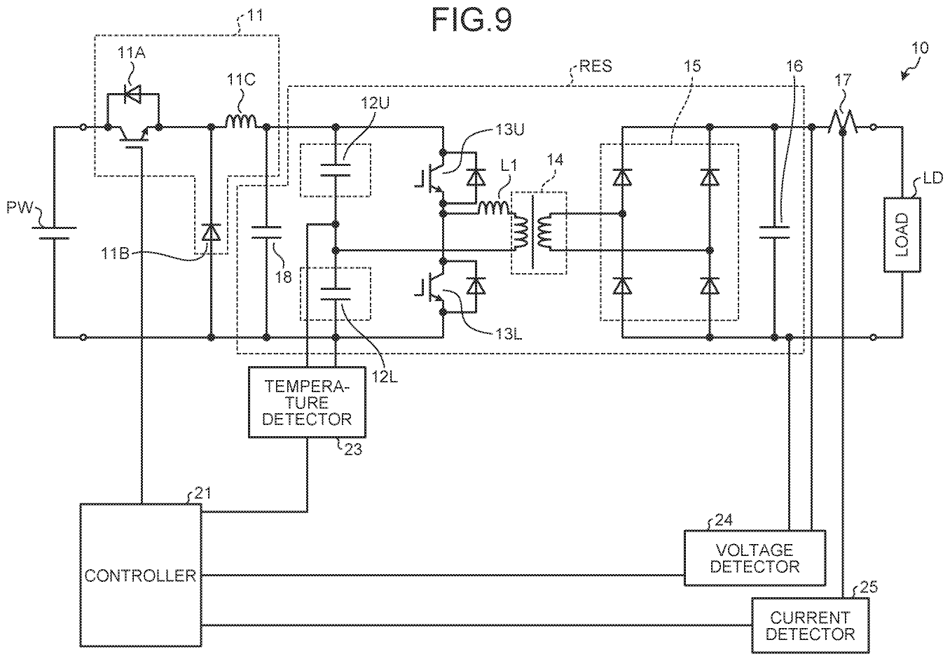

FIG. 9 is a schematic view for describing a configuration of a power conversion device according to a fourth embodiment.

As described in (1) above, factors that determine a resonant frequency include not only capacitance C but also inductance L.

In the fourth embodiment, the inductance L in a resonant circuit RES is enlarged.

The fourth embodiment illustrated in FIG. 9 is different from the first embodiment illustrated in FIG. 1 in that the power conversion device 10 is provided with a coil L1 as an inductance element between a connection point of switching elements 13U and 13L and a primary winding of a high frequency transformer 14.

Similarly to the first embodiment, the fourth embodiment enables the anomaly detection with ease and at low cost by detecting an anomalous resonant frequency based on a temperature and enables the protection of the power conversion device 10.

### [5] FIFTH EMBODIMENT

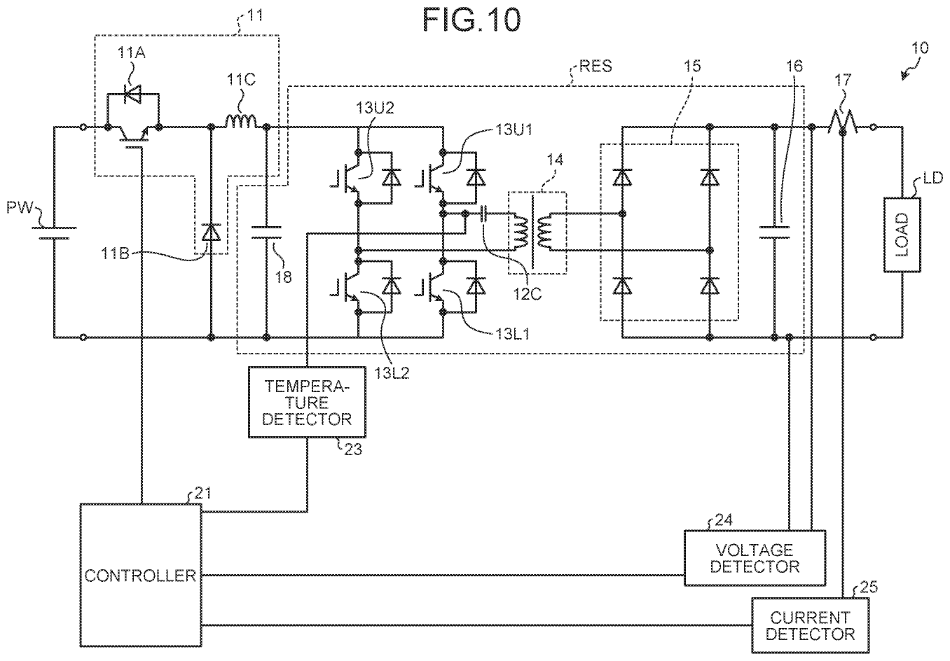

FIG. 10 is a schematic view for describing a configuration of a power conversion device according to a fifth embodiment.

The fifth embodiment illustrated in FIG. 10 is different from the second embodiment illustrated in FIG. 8 in that a resonant single-phase full-bridge inverter is employed instead of a resonant single-phase half-bridge inverter.

More specifically, instead of a switching element 13U and a switching element 13L, a switching element 13U1 and a switching element 13L1 are connected in series, and a connection point of the switching elements 13U1 and 13L1 is connected to one primary winding of a high frequency transformer 14. Furthermore, a switching element 13U2 and a switching element 13L2 are connected in series, and a connection point of the switching elements 13U2 and 13L2 is connected to the other primary winding of the high frequency transformer 14.

With this configuration, the switching elements 13U1, 13U2, 13L1, and 13L2 forms the full-bridge inverter.

Accordingly, as in the first embodiment, the fifth embodiment enables the detection of an anomalous resonant frequency with ease and at low cost and enables the protection of the power conversion device 10.

Furthermore, due to the full-bridge inverter, it is possible to make a voltage in the primary side equal to a power source voltage, which enables power source supply with a small current, that is, with low power consumption.

In the above example, a resonant capacitor 12C is disposed between the connection point of the switching elements 13U1 and 13L1 and the primary winding of the high frequency transformer 14, but a coil may also be disposed in series with the resonant capacitor 12C as necessary.

The embodiments of the invention have been described, but it should be noted that the embodiments are presented as examples and are not intended to limit the scope of the invention. These novel embodiments are implemented in various other forms, and omissions, substitutions, and modifications are allowed without departing from the gist of the invention. These embodiments and modifications thereof are included in the scope and gist of the invention and in the invention disclosed in the claims and the equivalent scope thereof.

For example, the invention may be a method performed by a power conversion device provided with a chopper configured to convert power from a power source into a direct current power and output the direct current power, an inverter configured to convert the direct current power output from the chopper into an alternate current power, a resonant capacitor included in a resonant circuit and connected in series with a direct-current input of the inverter, and a high frequency transformer configured to convert the alternate current power of the inverter, and the method may involve detecting a temperature of the resonant circuit, and detecting an anomalous resonant frequency when the temperature is equal to or higher than a predetermined temperature threshold to control an anomalous state.

Furthermore, the invention may be a program executed by a computer to control a power conversion device provided with a chopper configured to convert power from a power source into a direct current power and output the direct current power, an inverter configured to convert the direct current power output from the chopper into an alternate current power, a resonant capacitor included in a resonant circuit and connected in series with a direct-current input of the inverter, and a high frequency transformer configured to convert the alternate current power of the inverter, and the program may include functions of detecting a temperature of the resonant circuit and detecting an anomalous resonant frequency when the temperature is equal to or higher than a predetermined temperature threshold to control an anomalous state.

In the above description, the temperature detector 23 is illustrated as a member disposed close to the resonant capacitors, but the temperature detector 23 is not limited in position as long as the unit can detect a temperature change in accordance with an anomalous resonant frequency. For example, the temperature detector 23 may be placed in a part close to the high frequency transformer or other parts in the resonant circuit RES.

In the above description, a coil is employed as the inductance element, but another element such as a ferrite core and toroidal core may be employed.

1. A power conversion device comprising:
a voltage regulator circuit configured to regulate power from a power source to a desired voltage;
an inverter configured to convert the power output from the voltage regulator circuit into an alternate current power;
a resonant circuit having inductance and capacitance;
a high frequency transformer configured to convert the alternate current power of the inverter;
a rectifier configured to convert the alternate current power output from the high frequency transformer into a direct current power;
a temperature detector configured to detect a temperature of the resonant circuit; and
a controller configured to detect an anomalous resonant frequency when the temperature is equal to or higher than a predetermined temperature threshold to control an anomalous state.

2. The power conversion device according to claim 1, wherein
the controller is configured to control the anomalous state by stopping the power conversion device.

3. The power conversion device according to claim 1, wherein
the controller is configured to control the anomalous state by reducing output to a level lower than output in a normal state.

4. The power conversion device according to claim 1, wherein
the power conversion device further comprises a cooler configured to cool the resonant circuit, and
the controller is configured to control the anomalous state by cooling with the cooler.

5. The power conversion device according to claim 1, wherein
the resonant circuit includes, as the capacitance, a resonant capacitor connected to a direct-current input of the inverter.

6. The power conversion device according to claim 1, wherein
the resonant circuit includes, as the capacitance, a resonant capacitor connected between an alternate-current output of the inverter and a primary winding of the high frequency transformer.

7. The power conversion device according to claim 1, wherein
the resonant circuit includes, as the inductance, an inductance element connected between an alternate-current output of the inverter and a primary winding of the high frequency transformer.

8. The power conversion device according to claim 1, wherein
the voltage regulator circuit includes a chopper circuit or a converter circuit.

9. The power conversion device according to claim 1, wherein
the inverter includes a half-bridge inverter or a full-bridge inverter.

10. A control method for a power conversion device including a chopper configured to convert power from a power source into a direct current power and output the direct current power, an inverter configured to convert the direct current power output from the chopper into an alternate current power, a resonant capacitor included in a resonant circuit and connected in series with a direct-current input of the inverter, and a high frequency transformer configured to convert the alternate current power of the inverter,
the method comprising:
detecting a temperature of the resonant circuit; and
detecting an anomalous resonant frequency when the temperature is equal to or higher than a predetermined temperature threshold to control an anomalous state.
